(19) United States
(12) Patent Application Publication
(10) Pub. No.: US 2025/0379606 A1
(43) Pub. Date: Dec. 11, 2025

(54) POWER-DEPENDENT SELF-ACTUATION DEVICE FOR PROTECTING SENSITIVE RADIO FREQUENCY CIRCUITRY

(71) Applicant: Dell Products L.P., Round Rock, TX (US)

(72) Inventors: Tejinder Singh, Manotick (CA); Navjot Kaur Khaira, Manotick (CA)

(21) Appl. No.: 18/734,534

(22) Filed: Jun. 5, 2024

(51) Int. Cl. H04B 1/16

(52) U.S. Cl. CPC H04B 1/16

(57) ABSTRACT

The technology described herein is directed towards a multiport circulator device and switch that self-actuates based on RF power levels to protect radio frequency (RF) circuitry such as RF receivers from RF input signals that have sufficient power to damage the RF circuitry. Incoming signals are received at an input port of a multiport circulator device, with one output port coupled to the (e.g., metal-insulator transition) switch and another output port coupled to the RF circuitry. When incoming RF signals are below a threshold power, the self-actuating switch is in an insulating state, and the RF signal is reflected to the RF circuitry via its circulator output port. When the RF power exceeds the threshold power, the switch self-actuates/transitions to a conductive state, whereby the RF signal is routed by the circulator through the switch (and not the RF circuitry) to a load that thermally dissipates the energy.

### BACKGROUND

In radio frequency (RF) communication technologies, including wireless communication applications, robust protection devices are needed for sensitive RF circuitry such as RF receivers. This is particularly beneficial against high-power signals that can compromise system integrity or longevity. Traditional approaches, such as fuses, offer a one-time, destructive solution that necessitates manual intervention for system restoration, thereby interrupting service continuity and increasing maintenance costs. Furthermore, the complexity and energy dependency of existing protection methods introduce additional challenges in rapidly evolving and densely populated RF environments.

### BRIEF DESCRIPTION OF THE DRAWINGS

The technology described herein is illustrated by way of example and not limited in the accompanying figures in which like reference numerals indicate similar elements and in which:

FIG. 1A is a block diagram representation of an example radio frequency (RF) protection device, in accordance with various example embodiments and implementations of the subject disclosure.

FIG. 1B is a block diagram representation of the example RF protection device highlighting that when the input RF power satisfies a high power threshold level, a self-actuation device facilitates absorption of the high power into thermal losses, in accordance with various example embodiments and implementations of the subject disclosure.

FIG. 2 is a flow diagram showing an example decision-making process within the RF protection device described herein, in accordance with various example embodiments and implementations of the subject disclosure.

FIG. 3 is a top view representation of an example monolithic two-port self-actuation device of the RF protection device, including an enlarged internal view highlighting basic metallization and a metal-insulator transition material, in accordance with various example embodiments and implementations of the subject disclosure.

FIG. 4 is a representation of example design dimensions of the two-port self-actuation device, in which the dimensions can be adjusted as part of the design to optimize a threshold power level at which the two-port self-actuation switch device transitions between insulating and conducting states, in accordance with various example embodiments and implementations of the subject disclosure.

FIG. 5 is a three-dimensional view representation of an example self-actuation switch device, in accordance with various example embodiments and implementations of the subject disclosure.

FIG. 6 is a cross-sectional side view of an example self-actuation device of the RF protection system including a heat spreader and a heatsink installed to increase the threshold transition temperature, in accordance with various example embodiments and implementations of the subject disclosure.

FIG. 7 is a graphical representation of the resistivity versus temperature curve for one suitable metal-insulator transition material showing the transition between metallic conductor and insulator states, in accordance with various example embodiments and implementations of the subject disclosure.

FIG. 8 is a graphical representation of the rise time constant of one suitable metal-insulator transition material into the metallic and insulating phases, in accordance with various example embodiments and implementations of the subject disclosure.

FIG. 9 is a graphical representation of a simulation response of the power-dependent self-actuation switch device with varying channel lengths to change the threshold power level, including an enlarged portion thereof, in accordance with various example embodiments and implementations of the subject disclosure.

FIG. 10 is a flow diagram showing example operations related to implementing radio frequency power protection for radio frequency circuitry based on a circulator and power-dependent self-actuation switch device, in accordance with various example embodiments and implementations of the subject disclosure.

### DETAILED DESCRIPTION

The technology described herein is generally directed towards a radio frequency (RF) protection device/system that includes a power-dependent self-actuation switch aimed at safeguarding sensitive RF circuitry, including RF receivers or other RF devices. In one implementation, the RF protection device includes a monolithic power-dependent self-actuating switch device that employs a metal-insulator transition material, integrated within a multiport circulator device framework. The RF protection device has the characteristic ability to autonomously regulate RF signal direction to RF circuitry or a thermal dissipation (e.g., matched load) device based on a defined input power level, in which different switching devices can be defined for different input power levels through strategic design of the transition material's design dimensions.

In one implementation, the self-actuating switch device incorporates a metal-insulator transition material, which, along with an optimized heatsink, self-regulates based on RF signal input power levels, while also addressing the limitations of traditional protection devices through the self-actuating switch device's non-destructive, self-healing capabilities. This significantly enhances the protection, reliability, and efficiency of RF receivers and the like.

More particularly, when the incoming RF power surpasses a predetermined threshold power level defined as part of the switch design, the metal-insulator transition material becomes conductive due to heat generation, allowing signal passage to a thermal dissipation device, e.g., a broadband matched load for thermal dissipation. Signals below the threshold power are reflected to the RF circuitry, due to the switch's metal-insulator transition material being in an insulating state during low RF power conditions. The self-sufficient, adaptable RF protection device thus maintains signal integrity and receiver protection autonomously, without external controls, providing a non-destructive, self-healing alternative to traditional protection methods like fuses.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in RF communications and RF devices in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

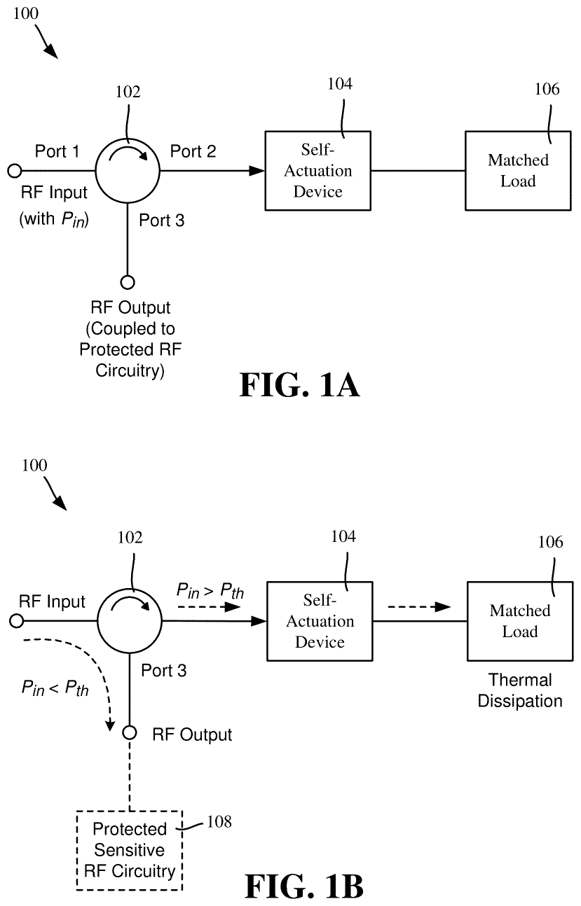

FIG. 1A is a block diagram representation of one example implementation of the RF protection device (system) 100, including a multiport circulator device 102, a self-actuation device 104 and a thermal dissipation device, shown in as a matched load 106. The RF input is the point of entry for the RF signals into the circulator 102, which in FIG. 1 is a non-reciprocal three-port device. The circulator 102 by default directs the flow of the RF energy (input power, Pᵢₙ) from port 1 to port 2; port 2 is an output port coupled to the self-actuation (switch) device 104. If the self-actuation device 104 is in the OFF-state, that is, in its insulating state, the input RF energy is reflected and routed to output port 3 of the circulator.

FIG. 1B shows additional details of the RF protection device 100, including the power-dependent self-actuation device 104, designed to protect sensitive RF circuitry 108 (e.g., RF receivers). Note that the dashed block representing the sensitive RF circuitry 108 indicates that generally the sensitive RF circuitry 108 is not part of the RF protection device 100, although it is feasible to have sensitive RF circuitry 108 include the RF protection device 100 as part of the RF circuitry's design.

As described with reference to FIG. 1A, the RF protection device/system 100 utilizes a circulator 102 as a directional device to channel RF signals, the direction of which is based on their power levels as described herein.

In one implementation, the self-actuation device 104 includes a metal-insulator transition (metal-insulator transition) material. The self-actuation device 104 is normally (due to typical signal conditions) in an insulating state, in which event the RF signals (with incoming RF power, Pᵢₙ, less than the threshold power Pₜₕ at which the metal-insulator transition material transitions, (Pᵢₙ<Pₜₕ)) to the self-actuation device 104 are reflected back, and the circulator 102 routes the RF signals to output port 3, whereby the RF signals reach the protected sensitive RF circuitry 108. Conversely, when the incoming RF power Pᵢₙ is greater than the threshold power Pₜₕ, (that is, Pᵢₙ>Pₜₕ), the RF signal's power is sufficient to heat the metal-insulator transition material past its transition temperature, causing the self-actuating switch device 104 to become conductive.

In the example of FIG. 1B, coupled to the self-actuation device 104 is a matched load 106 that serves to absorb the RF energy through thermal dissipation. In general, thermal dissipation is the process by which the matched load 106 absorbs and dissipates the energy from the RF signals when they exceed the threshold power level. The thermal energy is dissipated into the environment, protecting the RF circuitry (e.g., receiver) from high-power signals that could otherwise cause damage.

Thus, when the metal-insulator transition material becomes conductive, the RF energy is passed through to this matched load 106, which is designed to have an impedance that matches the system impedance, minimizing reflections and efficiently converting the RF energy into heat. It is straightforward to design a matched load, and is thus not described herein in detail; note that a monolithic broadband matched load has been easily developed. For example, one such matched load has been designed, fabricated, and evaluated, resulting in a wideband 50-ohm load measured from DC to 40 GHz with less than one percent variation across the band.

To summarize the RF output routing, when the incoming RF power is below the threshold, (Pᵢₙ<Pₜₕ), the metal-insulator transition material remains in its insulating state, and the RF signal is directed to the RF output port 3 of the circulator 102. This ensures that signals within the acceptable power range are passed through to the RF circuitry 108/RF receiver without any hindrance. When the incoming RF power is above the threshold, (Pᵢₙ>Pₜₕ), the metal-insulator transition material transitions to its conductive state, whereby the RF signal energy is directed to a matched load where the energy is thermally dissipated.

The technology described herein thus provides a self-regulating system/RF protection device that selectively channels high-power signals away from sensitive RF receivers or the like, thereby preventing potential damage. The RF protection device's design includes passive operation in one implementation, in which no external power sources or control systems are required for the RF protection device to function. The use of metal-insulator transition materials allows for a compact and integrated design, facilitating a more robust and reliable system that can enhance the longevity and performance of RF communication systems. The self-healing nature of the device, reverting back to an insulating state after cooling down, makes the device a sustainable and maintenance-free solution compared to traditional protective devices such as fuses.

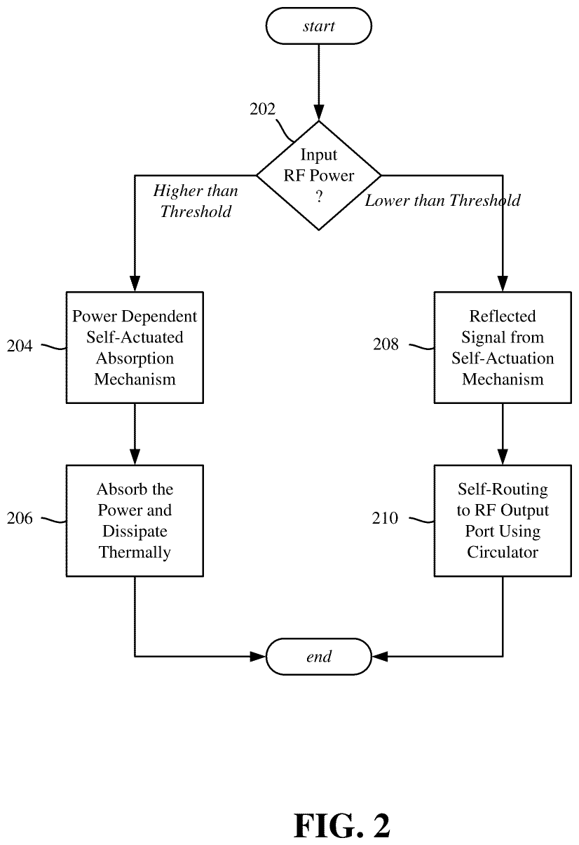

FIG. 2 summarizes example operations in a flow diagram, in which the decision process is inherent in the passive RF protection device described herein, (although logic in alternative active systems can perform such operations). In general, operation 202 represents assessing the input RF power level upon receiving a signal, in which the system determines whether the power is above or below a predetermined threshold. If the input power exceeds the threshold, the signal is directed to a power-dependent self-actuated absorption device (block 204), where it is absorbed and thermally dissipated at block 206. This device relies on the heat-induced transition of a metal-insulator material to become conductive, allowing for the absorption of excess power without external controls.

In the case of lower power signals, the device remains inactive, reflecting (block 208) the signal within the circulator. These signals are then self-routed to the RF output port 3 at block 210, ensuring that only signals within the safe operating range reach the sensitive RF receivers. This automated process continues cyclically, providing continuous protection and maintaining system integrity.

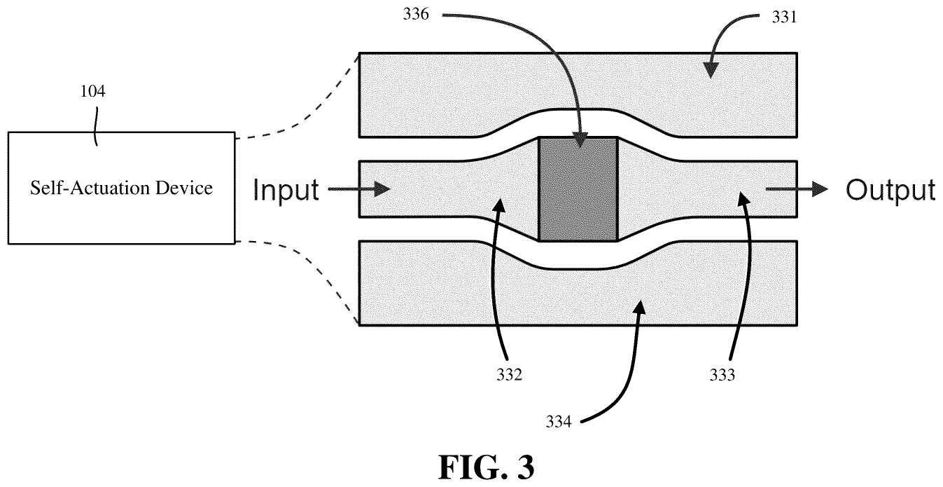

FIG. 3 shows an internal view of the power dependent self-actuation device 104 highlighting basic metallization and a metal insulator transition material. More particularly, in this example, between the signal direction input-to-output, is a two-port device implemented using a coplanar waveguide (CPW) configuration, formed using standard thin-film metallization (deposited metal strips or the like 331-334). A patch of metal-insulator transition material 336 is embedded monolithically between the central input-to-output signal line (between metal strips 332 and 333). Among other benefits, the monolithic aspect of the device does not need soldering or other post-fabrication configuration procedures.

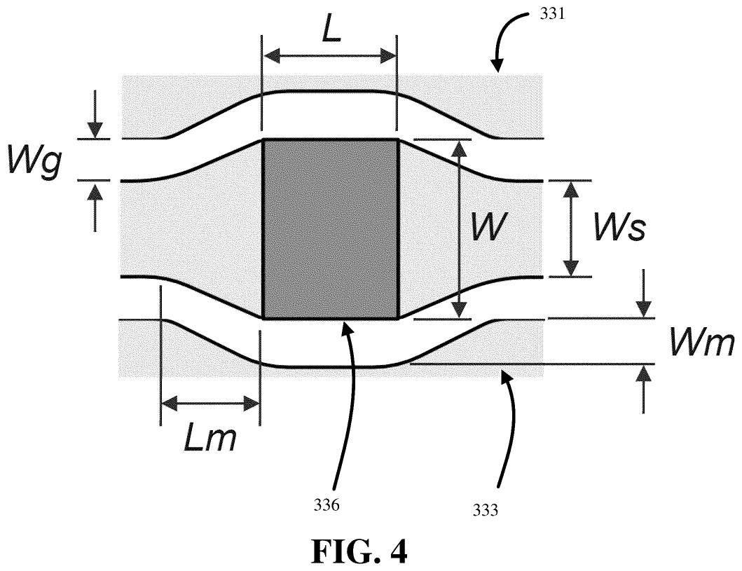

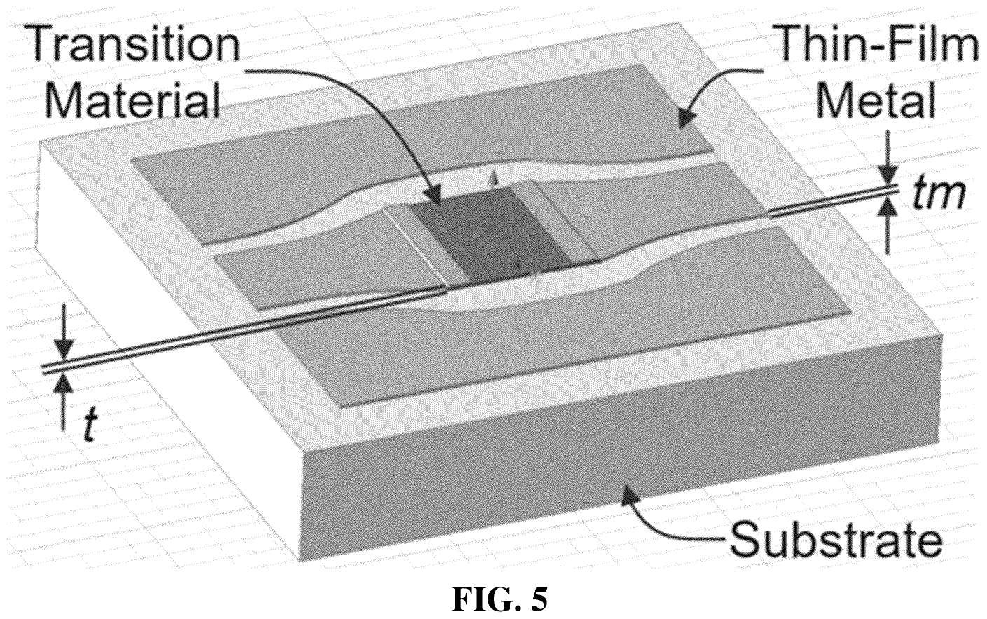

Various design dimensions to optimize the threshold power level are shown in FIG. 4 (partial top view representation) and FIG. 5 (perspective view representation) of the self-actuation device, which, for example, can be used for simulation in an EM modeler. As can be seen, width and length dimensions are shown in FIG. 4, while FIG. 5 depicts a substrate, along with dimensions represented for the thickness t of the transition material and the thickness tm of the thin film metal. Such dimensions are summarized in the following table:

| Design | |
|---|---|
| Variable | Description |
| Wₛ | Width of the RF transmission line |
| W_{g} | Gap between the signal line and ground plane of the |
| | CPW |
| Lm | Length of the taper in the signal line for impedance |
| | matching |
| Wm | Gap between the signal line and ground plane for the |
| | matching portion |
| L | Length of the metal-insulator transition material |
| | channel |
| W | Width of the metal-insulator transition material |
| | channel |
| t | Thickness of the metal-insulator transition |
| | material channel (FIG. 5) |
| tm | Thickness of the thin-film metal (FIG. 5) |

In one example implementation, the transition material's inherent temperature sensitivity, typically around 67° C. (degrees centigrade), adjustable up to 75° C. through deposition methods, can be further enhanced by attaching a heatsink. This modification elevates the threshold transition temperature beyond 85° C., ensuring the device remains inactive under high ambient temperatures to preserve its power-dependent functionality.

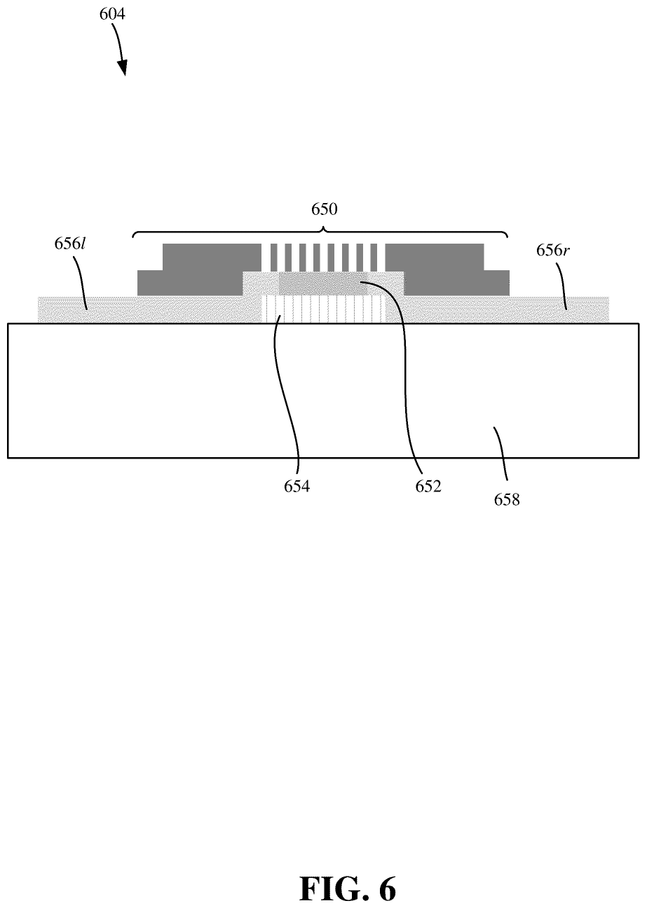

FIG. 6 shows across-sectional side view of one self-actuation device portion 604 (of the RF protection device). In this example, a heatsink 650 in conjunction with a heat spreader 652 are installed as part of the self-actuation device 604 to increase the threshold transition temperature of the metal-insulator transition material 654. The heatsink 650, heat spreader 652 and metal-insulator transition material 654 are surrounded by a metallization layer (6567 and 656r), which, along with metal-insulator transition material 654, are supported on a substrate 658.

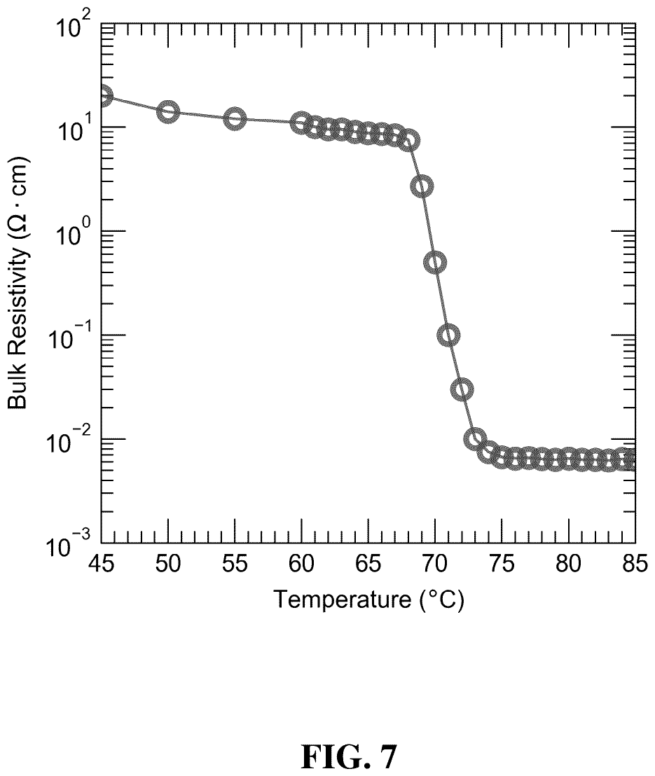

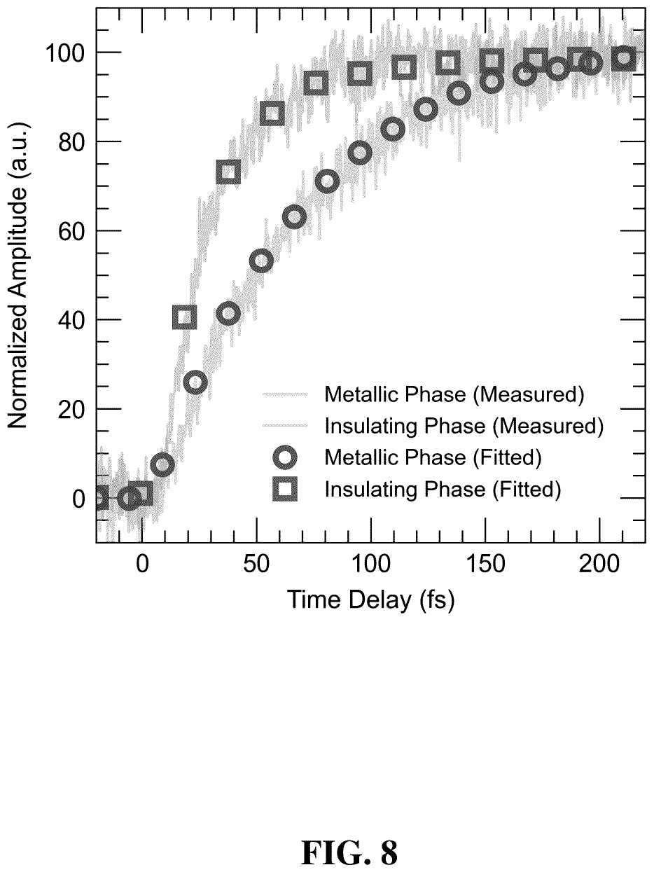

The transition phase can be optimized by a proper choice of the heat spreader 652 and the heatsink 650, which can be integrated heterogeneously or can be developed monolithically, using electroplating or any other process. The heat spreader 652 can be made using a high thermal conductivity dielectric material such as alumina nitride or similar material, as long as it can conduct the heat from the metal-insulator transition material 654 towards the heatsink 650, e.g., as shown in FIG. 6. Note that without the heatsink 650 and heat spreader 652, the self-actuation mechanism will still perform its intended operation, but with limited surrounding system temperature of around 67° C. as shown in FIG. 7, which graphically depicts the resistivity versus temperature curve for one suitable metal-insulator transition material (e.g., vanadium dioxide), showing the transition between the metallic conductive state and the insulator state. Such phase transition is graphically represented in FIG. 8 (normalized magnitude versus time delay in femtoseconds, fs), depicting the rise time constant of the material into the metallic and insulating phases; in general, this is much faster than fuses.

The device of FIG. 5, which highlights the material thickness and substrate, can be simulated using a commercial industry standard 3D finite element model. For such simulations, varying input power, Pᵢₙ, is applied at the input port. Based on the metal-insulator transition junction dimensions, output power was observed for four different metal-insulator transition channel dimensions. Although the thickness of the metal-insulator transition channel is not varied in these particular simulations, the threshold power level is adjusted based on the total volume of the material, which can further be optimized by tuning one or more of L×W×t. A higher volume of the material defines its bulk resistivity (insulating phase) at ambient temperature, and results in bulk conductivity (metallic phase) after transition temperature as shown in FIG. 7, along with the rise time constant of such phase transition as shown in FIG. 8. As set forth herein, the transition phase can be optimized by a proper choice of a heat spreader and a heatsink.

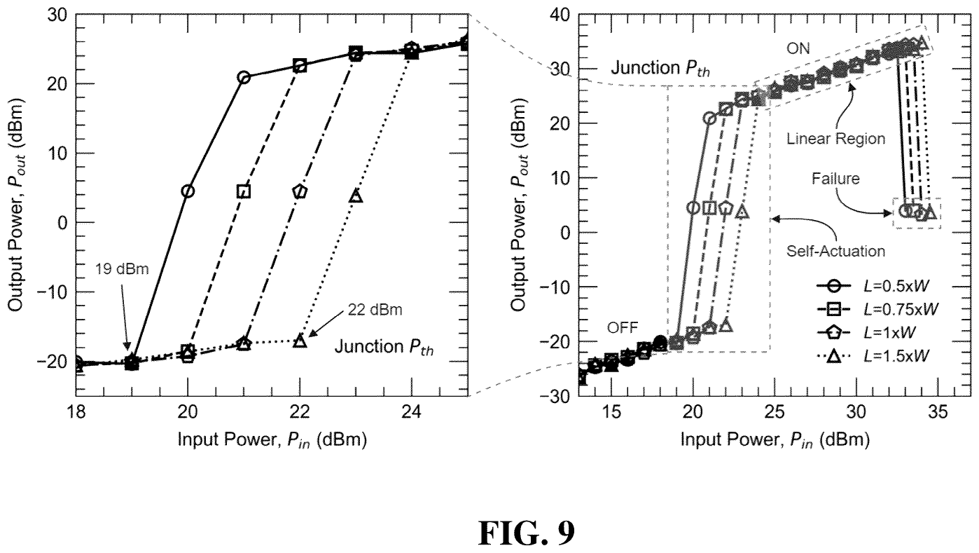

To demonstrate the power dependency, the simulations were carried out for four different metal-insulator transition channel dimensions to optimize the threshold power level, Pₜₕ, as shown in FIG. 9. For a specific thickness of the material (intentionally not specified herein, as the material parameters can be different depending on the deposition conditions), the threshold power level can be adjusted from 19 dBm to 22 dBm, which can further be optimized by increasing or decreasing the overall volume of the material monolithically integrated within the RF signal transmission line. Note that the differences in volumes are a result of four different length (L)-to-width (W) ratios ranging from L=0.5×W to L=1.5×W. The self-actuation region is indicated, with the left side of the FIG. 9 showing the zoomed-in view of the region of interest. For varying input power levels, the self-actuation device stays in the insulating state (OFF-state) and keeps reflecting the power towards output port 3 of the circulator; the moment the power level reaches the desired threshold level, the device self-actuates, and the high power starts travelling from output port 2 of the circulator, through the self-actuation device (the linear region of FIG. 9), and towards the matched load, where the high power is absorbed in the form of heat dissipation.

The limit of such miniaturized and monolithic self-actuation device is the failure power level, as graphically represented in the right portion of FIG. 9. The failure point is the catastrophic failure of the device, when the RF power level exceeds a very high level; for example, for the chosen volumes of the material, the failure point is between 33 to 35 dBm (2 to 3.5 Watts). This failure point can be increased by further increasing the volume, which increases the threshold level proportionally. In case the power level reaches failure point, the power level destructively damages the metal-insulator transition channel, defining the upper-limit of this self-actuating switch device. A fuse or the like designed for blowing somewhat close to but below such a catastrophic power level for a given self-actuating switch can prevent damaging the metal-insulator transition channel, although manual fuse replacement would be needed, along with the added cost of the fuse.

One or more example embodiments can be embodied in a system, such as described and represented herein. The system can include a power-dependent radio frequency switch that self-actuates in response to input power of incoming radio frequency signals satisfying a defined threshold high radio frequency power level, resulting in coupling the incoming radio frequency signals to a thermal dissipation device and not coupling the incoming radio frequency signals to radio frequency circuitry, and self-de-actuates in response to the input power of the incoming radio frequency signals not satisfying the defined threshold high radio frequency power level, resulting in coupling the incoming radio frequency signals to the radio frequency circuitry and not coupling the incoming radio frequency signals to the thermal dissipation device.

The incoming radio frequency signals can be coupled to a first port of a multi-port device circulator; the multi-port device circulator can include a second port coupled to the power-dependent radio frequency switch and used to couple the incoming radio frequency signals to the thermal dissipation device and not couple the incoming radio frequency signals to radio frequency circuitry in response to the power-dependent radio frequency switch self-actuating, and the multi-port device circulator can include a third port coupled to the radio frequency circuitry and used to couple the incoming radio frequency signals to the radio frequency circuitry and not couple the incoming radio frequency signals to the thermal dissipation device in response to the power-dependent radio frequency radio switch self-de-actuating.

The thermal dissipation device can include a broadband matched load.

The power-dependent radio frequency switch can include a metal-insulator transition material.

The defined threshold high radio frequency power level can be determined at least in part by a total volume of the metal-insulator transition material.

The metal-insulator transition material can include a metal-insulator transition channel, and the threshold power level can be further tunable based on at least one of: a length of the metal-insulator transition channel, a width of the metal-insulator transition channel, or a thickness of the metal-insulator transition channel.

The defined threshold high radio frequency power level can correspond to a defined transition temperature between approximately sixty-five degrees centigrade and seventy-seven degrees centigrade.

The defined threshold high radio frequency power level can correspond to a defined transition temperature, and further can include a heatsink thermally coupled to the power-dependent radio frequency switch to influence the defined transition temperature.

The metal-insulator transition material, in conjunction with the heatsink, can facilitate an insulating state-to-conducting state transition of the metal-insulator transition material at the defined transition temperature of greater than eighty degrees centigrade.

The power-dependent radio frequency switch can include vanadium dioxide.

The radio frequency circuitry can include at least one of: a radio frequency receiver, or a radio frequency device.

The power-dependent radio frequency switch can be fabricated as a single unit.

The power-dependent radio frequency switch can include a two-port, input-to-output device implemented according to a coplanar waveguide configuration.

One or more example embodiments can be embodied in a system, such as described and represented herein. The system can include a power-dependent radio frequency switch and a multi-port device circulator. The multi-port device circulator can include a first port of a multi-port device circulator coupled to incoming radio frequency signals, a second port coupled to the power-dependent radio frequency switch, and a third port coupled to radio frequency circuitry. The power-dependent radio frequency switch can self-actuate into a conductive state based on radio frequency input power of the incoming radio frequency signals satisfying a defined threshold power level, resulting in coupling the incoming radio frequency signals to a thermal dissipation device. The power-dependent radio frequency switch can self-de-actuate into an insulating state based on the radio frequency input power of the incoming radio frequency signals not satisfying the defined threshold power level, resulting in coupling the incoming radio frequency signals to the radio frequency circuitry.

The power-dependent radio frequency switch can include a metal-insulator transition material.

The defined threshold high radio frequency power level can correspond to a defined transition temperature, and further can include a heatsink thermally coupled to the metal-insulator transition material to influence the defined transition temperature.

The heatsink can be thermally coupled to the metal-insulator transition material via a heat spreader.

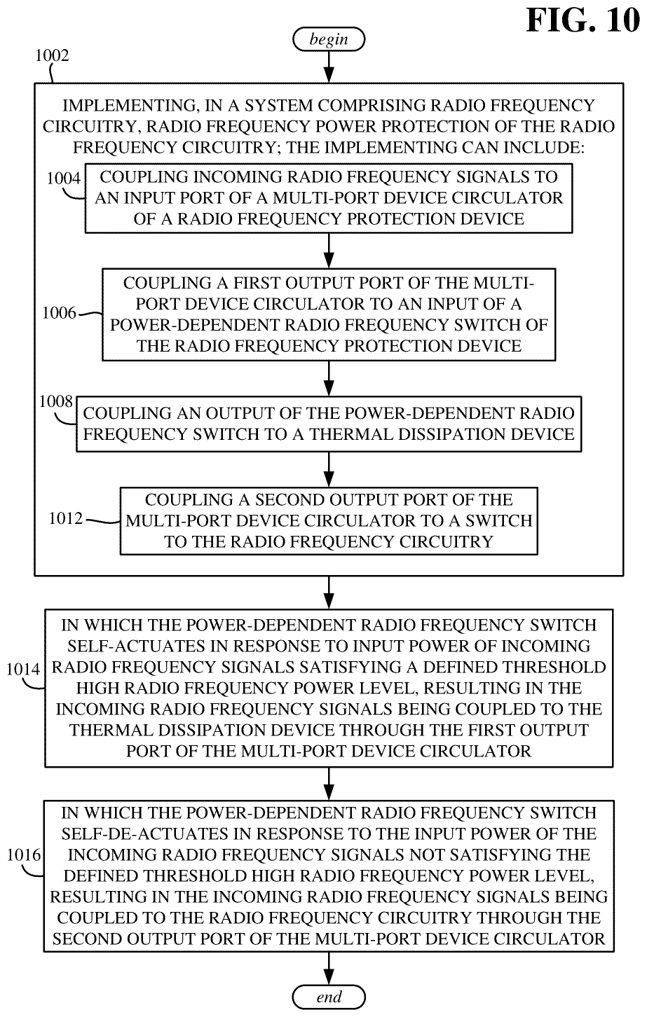

One or more example aspects, such as corresponding to example operations of a method, or a system/a machine-readable medium having executable instructions that, when executed by a processor, facilitate performance of the operations, are represented in FIG. 10. Example operation 1002 represents implementing, in a system comprising radio frequency circuitry, radio frequency power protection of the radio frequency circuitry. The implementing can include operations 1004, 1006, 1008 and 1008. Example operation 1004 represents coupling incoming radio frequency signals to an input port of a multi-port device circulator of a radio frequency protection device. Example operation 1006 represents coupling a first output port of the multi-port device circulator to an input of a power-dependent radio frequency switch of the radio frequency protection device. Example operation 1008 represents coupling an output of the power-dependent radio frequency switch to a thermal dissipation device. Example operation 1010 represents coupling a second output port of the multi-port device circulator to a switch to the radio frequency circuitry. The power-dependent radio frequency switch self-actuates (example block 1012) in response to input power of incoming radio frequency signals satisfying a defined threshold high radio frequency power level, resulting in the incoming radio frequency signals being coupled to the thermal dissipation device through the first output port of the multi-port device circulator. The power-dependent radio frequency switch self-de-actuates (example block 1014) in response to the input power of the incoming radio frequency signals not satisfying the defined threshold high radio frequency power level, resulting in the incoming radio frequency signals being coupled to the radio frequency circuitry through the second output port of the multi-port device circulator.

Implementing of the radio frequency power protection further can include thermally coupling the power-dependent radio frequency switch to a heatsink.

Implementing of the radio frequency power protection further can include determining the defined threshold high radio frequency power level based on selecting design dimensions of a metal-insulator transition material of the power-dependent radio frequency switch.

As can be seen, the technology described herein is directed to a radio frequency power protection device based on a self-actuating and self-de-actuating power-dependent radio frequency switch. Employing such a power-dependent switch can controllably and significantly protect sensitive RF circuitry. The device self-activation, based on the power level of incoming RF signals, distinguishes between signals that need to be absorbed and those that are to be reflected, and does so without external control, making it power-dependent.

In addition, the integration of a heatsink allows for precise control over the metal-insulator transition temperature, enabling the device to maintain its functionality across a broad range of ambient system temperatures. Further, unlike traditional fuses that require replacement after tripping, this RF protection device is self-healing, allowing for continuous operation even after exposure to high power levels. The device can be fabricated as a single, cohesive unit, enhancing reliability, and simplifying the overall design compared to systems with multiple discrete components.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a power-dependent radio frequency switch that:
self-actuates in response to input power of incoming radio frequency signals satisfying a defined threshold high radio frequency power level, resulting in coupling the incoming radio frequency signals to a thermal dissipation device and not coupling the incoming radio frequency signals to radio frequency circuitry, and
self-de-actuates in response to the input power of the incoming radio frequency signals not satisfying the defined threshold high radio frequency power level, resulting in coupling the incoming radio frequency signals to the radio frequency circuitry and not coupling the incoming radio frequency signals to the thermal dissipation device.

2. The system of claim 1, wherein the incoming radio frequency signals are coupled to a first port of a multi-port device circulator, the multi-port device circulator comprising a second port coupled to the power-dependent radio frequency switch and used to couple the incoming radio frequency signals to the thermal dissipation device and not couple the incoming radio frequency signals to radio frequency circuitry in response to the power-dependent radio frequency switch self-actuating, and the multi-port device circulator comprising a third port coupled to the radio frequency circuitry and used to couple the incoming radio frequency signals to the radio frequency circuitry and not couple the incoming radio frequency signals to the thermal dissipation device in response to the power-dependent radio frequency radio switch self-de-actuating.

3. The system of claim 1, wherein the thermal dissipation device comprises a broadband matched load.

4. The system of claim 1, wherein the power-dependent radio frequency switch comprises a metal-insulator transition material.

5. The system of claim 4, wherein the defined threshold high radio frequency power level is determined at least in part by a total volume of the metal-insulator transition material.

6. The system of claim 5, wherein the metal-insulator transition material comprises a metal-insulator transition channel, and wherein the threshold power level is further tunable based on at least one of: a length of the metal-insulator transition channel, a width of the metal-insulator transition channel, or a thickness of the metal-insulator transition channel.

7. The system of claim 6, wherein the defined threshold high radio frequency power level corresponds to a defined transition temperature between approximately sixty-five degrees centigrade and seventy-seven degrees centigrade.

8. The system of claim 1, wherein the defined threshold high radio frequency power level corresponds to a defined transition temperature, and further comprising a heatsink thermally coupled to the power-dependent radio frequency switch to influence the defined transition temperature.

9. The system of claim 8, wherein the metal-insulator transition material, in conjunction with the heatsink, facilitates an insulating state-to-conducting state transition of the metal-insulator transition material at the defined transition temperature of greater than eighty degrees centigrade.

10. The system of claim 1, wherein the power-dependent radio frequency switch comprises vanadium dioxide.

11. The system of claim 1, wherein the radio frequency circuitry comprises at least one of: a radio frequency receiver, or a radio frequency device.

12. The system of claim 1, wherein the power-dependent radio frequency switch is fabricated as a single unit.

13. The system of claim 1, wherein the power-dependent radio frequency switch comprises a two-port, input-to-output device implemented according to a coplanar waveguide configuration.

14. A system, comprising:
a power-dependent radio frequency switch; and
a multi-port device circulator, comprising:
a first port of a multi-port device circulator coupled to incoming radio frequency signals,
a second port coupled to the power-dependent radio frequency switch, and
a third port coupled to radio frequency circuitry;
wherein the power-dependent radio frequency switch self-actuates into a conductive state based on radio frequency input power of the incoming radio frequency signals satisfying a defined threshold power level, resulting in coupling the incoming radio frequency signals to a thermal dissipation device, and
wherein the power-dependent radio frequency switch self-de-actuates into an insulating state based on the radio frequency input power of the incoming radio frequency signals not satisfying the defined threshold power level, resulting in coupling the incoming radio frequency signals to the radio frequency circuitry.

15. The system of claim 14, wherein the power-dependent radio frequency switch comprises a metal-insulator transition material.

16. The system of claim 15, wherein the defined threshold high radio frequency power level corresponds to a defined transition temperature, and further comprising a heatsink thermally coupled to the metal-insulator transition material to influence the defined transition temperature.

17. The system of claim 16, wherein the heatsink is thermally coupled to the metal-insulator transition material via a heat spreader.

18. A method, comprising:
implementing, in a system comprising radio frequency circuitry, radio frequency power protection of the radio frequency circuitry, the implementing comprising:
coupling incoming radio frequency signals to an input port of a multi-port device circulator of a radio frequency protection device,
coupling a first output port of the multi-port device circulator to an input of a power-dependent radio frequency switch of the radio frequency protection device,
coupling an output of the power-dependent radio frequency switch to a thermal dissipation device, and
coupling a second output port of the multi-port device circulator to a switch to the radio frequency circuitry;
wherein the power-dependent radio frequency switch self-actuates in response to input power of incoming radio frequency signals satisfying a defined threshold high radio frequency power level, resulting in the incoming radio frequency signals being coupled to the thermal dissipation device through the first output port of the multi-port device circulator, and
wherein the power-dependent radio frequency switch self-de-actuates in response to the input power of the incoming radio frequency signals not satisfying the defined threshold high radio frequency power level, resulting in the incoming radio frequency signals being coupled to the radio frequency circuitry through the second output port of the multi-port device circulator.

19. The method of claim 18, wherein the implementing of the radio frequency power protection further comprises thermally coupling the power-dependent radio frequency switch to a heatsink.

20. The method of claim 18, wherein the implementing of the radio frequency power protection further comprises determining the defined threshold high radio frequency power level based on selecting design dimensions of a metal-insulator transition material of the power-dependent radio frequency switch.
